(19) United States
(12) Patent Application Publication
(10) Pub. No.: US 2025/0012309 A1
(43) Pub. Date: Jan. 9, 2025

(54) LOCKING DEVICE FOR A JOINERY PRODUCT

(71) Applicant: Välinge Innovation AB, Viken (SE)

(72) Inventor: Thomas MEIJER, VIKEN (SE)

(73) Assignee: Välinge Innovation AB, Viken (SE)

(21) Appl. No.: 18/764,217

(22) Filed: Jul. 4, 2024

(30) Foreign Application Priority Data
Jul. 5, 2023 (SE) 2350844-3

(51) Int. Cl. F16B 12/20; F16B 12/10

(52) U.S. Cl. CPC F16B 12/2036; F16B 2012/106; F16B 2012/2018

(57) ABSTRACT

A locking device for a joinery product is provided, the locking device including a locking pin, and a rotatable plug element. The plug element has at least one engagement means configured to interact with the locking pin such that in a first rotation state of the plug element, the locking pin is positionable in a first position, and in a second rotation state of the plug element, the locking pin is positionable in a second position, different from the first position.

### CROSS REFERENCE TO RELATED APPLICATIONS

The present application claims the benefit of Swedish Application No. 2350844-3, filed on Jul. 5, 2024. The entire contents of Swedish Application No. 2350844-3 are hereby incorporated herein by reference in their entirety.

### TECHNICAL FIELD

The present disclosure relates to a locking device for a joinery product, a joinery product, and a method for producing a joinery product.

### BACKGROUND

A furniture product provided with a mechanical locking element is known in the art, e.g., by WO 2015/038059. The furniture product comprises a first panel connected to a second panel by a mechanical locking element comprising a rod-shaped element, an insertion groove, a locking groove, and a locking element.

There is a need for a locking device for a joinery product of joinery elements with an improved locking.

### SUMMARY

It is an object of at least embodiments of the present disclosure to provide an improvement over the above described techniques and known art.

Another object of at least embodiments of the present disclosure is to provide a locking device which facilitates the production of a joinery product, and which facilitates dismantling of the joinery product.

In a first aspect, a locking device for a joinery product is provided, the locking device comprising a locking pin, and a rotatable plug element. The plug element has at least one engagement means configured to interact with the locking pin such that in a first rotation state of the plug element, the locking pin is positionable in a first position, and in a second rotation state of the plug element, the locking pin is positionable in a second position, different from the first position.

This locking device is advantageous in that the two rotational states of the plug element provide a possibility to arrange the locking pin in two different positions. One of the positions may be a locked position and the other of the positions may be an unlocked position. The locking pin may be positioned in both a locked position and an unlocked position without the need of removing the plug element. This is advantageous in that the plug element is less likely to be lost during maneuvering of the locking device and of the joinery product.

In one embodiment, the locking pin is unsupported by the engagement means in the first position, and supported by the engagement means in the second position.

In one embodiment, the engagement means comprises at least one support means configured to support the locking pin in the second position.

In one embodiment, the at least one support means is arranged such that the at least one support means abut an end portion of the locking pin such that the locking pin is supported by the at least one support means in the second position.

In one aspect, a locking device for a joinery product is provided. The locking device comprises a compressible locking pin comprising a flange, and a rotatable plug element.

The plug element has at least one engagement means comprising two curved arms. In a first rotation state of the plug element, the locking pin is positioned in a first position, and in a second rotation state of the plug element, the locking pin is positioned in a second position, different from the first position. The first position is an unlocked position, and the second position is a locked position of the locking device. Upon rotation of the plug element from the second rotation state to the first rotation state, the curved arms are configured, by interaction with said flange, to pull the locking pin from the locked position to the unlocked position.

In one embodiment, the compressible locking pin is de-compressible to an initial state after having been compressed.

In one embodiment, in the first rotation state of the plug element, the at least one support means is located in a non-supportive position in relation to the locking pin, and, in the second rotation state of the plug element, the at least one support means is rotated approximately +/−90° compared to the orientation of the at least one support means in the first rotation state of the plug element.

In one embodiment, the locking pin comprises a flange, and the engagement means further comprises guide means configured to interact with said flange.

In one embodiment, the guide means comprises two curved arms configured to interact with the flange of the locking pin, and configured, upon rotation of the plug element from the first rotation state to the second rotation state, to push the locking pin from the first position to the second position. This configuration is advantageous in that the locking pin is maneuverable via the guide means.

In one embodiment, upon rotation of the plug element from the second rotation state to the first rotation state, the guide means are configured to pull the locking pin from the second position to the first position. The guide means are advantageous in that the locking pin may be put in both the first rotation state and the second rotation state by interaction with the guide means.

In one embodiment, the plug element comprises an opening arranged in a 90° angle in relation to the at least one support means, and wherein the opening is configured to receive the locking pin in the first position.

In one embodiment, the plug element comprises two support means, provided on respective sides of the opening.

In one embodiment, in the second position, the locking pin is configured to be supported by one of the two support means.

In one embodiment, the plug element further comprises at least one through recess configured to provide access to the locking pin, optionally by means of a tool (e.g., a screwdriver).

In one embodiment, the locking pin is maneuverable between the first and second positions via the at least one recess, optionally by means of a tool.

In one embodiment, the plug element comprises an indentation configured to receive the locking pin in the first position.

In one embodiment, the locking device further comprising two support means provided on respective sides of the indentation, wherein the locking pin is configured to be supported by both support means in the second position.

In one embodiment, the locking pin and/or the rotatable plug element comprises a polymer material, such as a thermoplastic material.

In one embodiment, the rotatable plug element is injection moulded in one piece.

In a second aspect, a joinery product is provided, comprising a first joinery element having a first edge surface, a second edge surface and a first joinery element surface. A first attaching surface is at least part of said first edge surface or said second edge surface.

The joinery product further comprises a second joinery element having a second joinery element surface, a third joinery element surface, a third edge surface and a fourth edge surface, wherein a second attaching surface is at least part of said second joinery element surface, the third edge surface or the fourth edge surface, wherein a locking recess is provided in the second attaching surface, and wherein the first attaching surface faces and is configured to be locked with the second attaching surface.

The joinery product further comprises a locking device comprising a locking pin positioned partially in a first joinery element recess provided in the first attaching surface, and configured to be received by the locking recess in the second attaching surface.

The first joinery element comprises an unlocking opening in the first joinery element surface or in a thereto opposite surface, wherein a plug element is arranged in the unlocking opening in operative connection with the locking pin and configured to interact with the locking pin such that in a first rotation state of the plug element, the locking pin is positionable in a first position extracted from the locking recess, and in a second rotation state of the plug element, the locking pin is locked in a second position, at least party extending into the locking recess.

In one embodiment, the plug element comprises at least one engagement means configured to interact with the locking pin.

In one embodiment, the locking pin is supported by engagement means in the second position, and released from the engagement means in the first position.

In one embodiment, the engagement means comprises at least one support means configured to support the locking pin in the second position.

In one embodiment, in the first rotation state of the plug element, the at least one support means is located in a non-supportive position in relation to the locking pin, and, in the second rotation state of the plug element, the at least one support means is rotated approximately +/−90° compared to the orientation of the at least one support means in the first rotation state of the plug element.

In one embodiment, the unlocking opening is provided in the first joinery element surface or in a thereto opposite surface.

In one embodiment, the first joinery element recess is provided in the first attaching surface.

In one embodiment, the first joinery element recess extends in a direction perpendicular to the main extension of the unlocking opening.

In one embodiment, the plug element comprises at least one engagement means configured to interact with the locking pin such that the locking pin is movable between the first position and second position, respectively.

In one embodiment, the locking pin comprises a flange in an end portion located in the first joinery element recess, and the engagement means further comprises guide means configured to interact with said flange.

In one embodiment, the guide means comprises two curved arms configured to interact with the flange of the locking pin, and, upon rotation of the plug element from the first rotation state to the second rotation state, configured to push the locking pin from the first position to the second position.

In one embodiment, upon rotation of the plug element from the second rotation state to the first rotation state, the guide means are configured to pull the locking pin from the second position to the first position.

In one embodiment, the plug element comprises an opening arranged in a 90° angle in relation to the at least one support means, and the opening is configured to receive the locking pin in the first position of the locking pin.

In one embodiment, the plug element comprises two support means, provided on respective sides of the opening.

In one embodiment, the locking pin is supported by one of the support means in the second position.

In one embodiment, the plug element comprises at least one through recess configured to provide access to the locking pin.

In one embodiment, the at least one through recess is provided in a plane of the plug element substantially parallel with the first joinery element surface.

In one embodiment, the locking pin is maneuverable between the first and second positions via the at least one recess, optionally by means of a tool.

In one embodiment, the plug element comprises an indentation configured to receive the locking pin in the first position.

In one embodiment, the joinery product further comprises two support means provided on respective sides of the indentation, wherein the locking pin is supported by both support means in the second position.

In one embodiment, the plug element comprises at least one through recess configured to provide access to the locking pin.

In one embodiment, the at least one through recess is provided in a plane of the plug element substantially parallel with the first joinery element surface.

In one embodiment, the locking pin is maneuverable between the first and second positions via the at least one through recess, optionally by means of a tool.

In a third aspect, a method for producing a joinery product is provided, the method comprising the steps of:
providing a first joinery element having a first edge surface, a second edge surface and a first joinery element surface, wherein a first attaching surface is at least part of said first edge surface or said second edge surface, the first joinery element further comprising a first joinery element recess and an unlocking opening, the first joinery element recess and the unlocking opening being in connection with each other,
providing a second joinery element having a second joinery element surface, a third joinery element surface, a third edge surface and a fourth edge surface, wherein a second attaching surface is at least part of said second joinery element surface, the third edge surface or the fourth edge surface, wherein a locking recess is provided in the second attaching surface,
arranging a plug element in the unlocking opening, the plug element being in a first rotation state,
arranging a locking pin in the first joinery element recess, the locking pin being in operative connection with the plug element,
arranging the first joinery element and second joinery element such that the first joinery element recess faces the locking recess,
displacing the locking pin to extend at least partially into the locking recess, rotating the plug element to a second rotation state.

In one embodiment, in the first rotation state of the plug element, the locking pin is unsupported by the engagement means, and in the second rotation state of the plug element, the locking pin is supported by the engagement means.

In one embodiment, the step of rotating the plug element to the second rotation state comprises providing support to the locking pin by the engagement means.

In one embodiment, the step of rotating the plug element between a first and a second rotation state comprises rotating the plug element approximately +/−90°.

In one embodiment, the method further comprises a step of rotating the plug element from the second rotation state to the first rotation state in order to dismantle the joinery product.

In one embodiment, the method further comprises a step of extracting the locking pin from the locking recess in order to dismantle the joinery product.

In one embodiment, the locking pin comprises a flange in an end portion located in the first joinery element recess, and wherein the engagement means further comprises guide means, wherein in the step of displacing the locking pin, the guide means interact with said flange to move the locking pin between the first and second positions, respectively.

In one embodiment, the guide means comprises two curved arms, wherein in the step of displacing the locking pin, said curved arms interact with the flange of the locking pin, and, in the step of rotating the plug element from the first rotation state to the second rotation state, push the locking pin from the first position to the second position.

In one embodiment, in the step of rotating of the plug element from the second rotation state to the first rotation state, the guide means pull the locking pin from the second position to the first position.

In one embodiment, the step of displacing the locking pin to extend at least partially into the locking recess comprises removing the locking pin from the opening in the plug element.

In one embodiment, the step of rotating the plug element to a second rotation state comprises rotating the plug element such that one of the two support means is located adjacent an end portion of the locking pin, preferably such that such that one of the two support means abuts the end portion of the locking pin to support the locking pin in the second position.

In one embodiment, the step of displacing the locking pin comprises maneuvering the locking pin between the first and second positions via the at least one recess in the plug element, optionally by means of a tool.

In one embodiment, the step of displacing the locking pin to extend at least partially into the locking recess comprises removing the locking pin from the indentation.

In one embodiment, the step of rotating the plug element to a second rotation state comprises rotating the plug element such that two support means of the plug element are located in contact with the locking pin, preferably such that the support means abut an end portion of the locking pin to support the locking pin in the second position.

In one embodiment, the step of displacing the locking pin comprises maneuvering the locking pin between the first and second positions via at least one recess in the plug element, optionally by means of a tool.

In one aspect, a rotatable plug element for a joinery product is provided. The joinery product comprises a locking device, and the rotatable plug element is configured to cooperate with a locking element of the locking device.

In one aspect, a locking device for a joinery product is provided. The locking device comprises a compressible locking pin, and a rotatable plug element having at least one engagement means comprises at least one support means, and an opening arranged in a 90° angle in relation to the at least one support means. In a first rotation state of the plug element, the locking pin is positioned in a first position, and in a second rotation state of the plug element, the locking pin is positioned in a second position, different from the first position. The opening is configured to receive the locking pin in the first rotation state of the plug element.

In one aspect, a locking device for a joinery product, the locking device comprising a compressible locking pin, and a rotatable plug element comprising an indentation. In a first rotation state of the plug element, the locking pin is positioned in a first position, and in a second rotation state of the plug element, the locking pin is positioned in a second position, different from the first position. The indentation is configured to receive a portion of the locking pin in the first rotation state of the plug element.

### BRIEF DESCRIPTION OF THE DRAWINGS

The present disclosure will by way of example be described in more detail with reference to the appended schematic drawings, which show embodiments of the present disclosure.

FIGS. 1-3 show schematic perspective views of different embodiments of the disclosure having different configurations of two joinery elements in locked position,

FIGS. 4-8 are various views of a plug element according to an embodiment of the present disclosure, FIG. 4 being a perspective view of a plug element (with transparency),

FIG. 5 being a perspective view of a disc element of the plug element, and FIGS. 6-8 being laterals view thereof (with transparency),

FIGS. 9-10 respectively show a lateral view and a perspective view of an embodiment of a locking pin according to an embodiment of the present disclosure,

FIGS. 11-16 show a locking device according to an embodiment of the present disclosure in different stages of locking,

FIGS. 17-22 are various views of a plug element according to one embodiment according to an embodiment of the present disclosure,

FIGS. 23-25 show a locking device according to an embodiment of the present disclosure in an unlocked state,

FIGS. 26-28 show the locking device in FIGS. 23-25 in a locked state,

FIGS. 29-32 are various views of a plug element according to one embodiment according to an embodiment of the present disclosure,

FIGS. 33-35 show a locking device according to an embodiment of the present disclosure in an unlocked state,

FIGS. 36-38 shows the locking device in FIGS. 33-35 in a locked state,

FIG. 39 show a cross-sectional side view of the attaching of one joinery element to another joinery element with a locking device according to an embodiment of the joinery product of the present disclosure,

FIG. 40 shows a piece of furniture (a bookshelf) according to an embodiment of the joinery product according to the disclosure, and

FIG. 41 shows a frame according to an embodiment of the joinery product according to the disclosure.

Further, in the figures like reference characters designate like or corresponding parts throughout the several figures.

### DETAILED DESCRIPTION

Specific embodiments of the disclosure now will be described with reference to the accompanying drawings. This disclosure may, however, be embodied in many different forms and should not be construed as limited to the embodiments of the joinery product put forth herein; rather, these embodiments are provided so that this disclosure will be thorough and complete, and will fully convey the scope of the disclosure to those skilled in the art. The terminology used in the detailed description of the embodiments illustrated in the accompanying drawings is not intended to be limiting of the disclosure. In the drawings and in the description, like numbers refer to like elements.

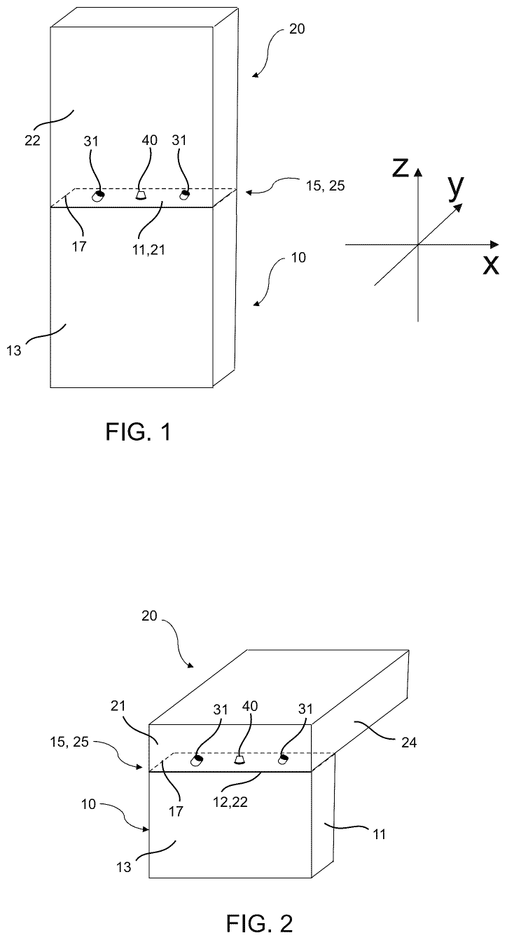

FIGS. 1 to 3 show schematic perspective views of a joinery product according to embodiments of the disclosure. In particular, different configurations of two joinery elements in locked position are shown. Thus, not all details and features are shown in FIGS. 1 to 3.

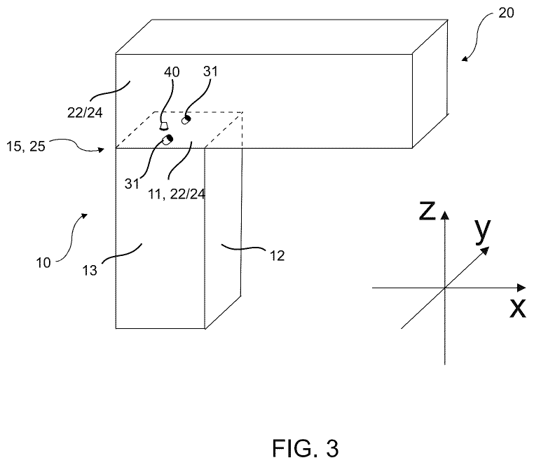

The joinery product comprises a first joinery element 10 having a first edge surface 11, a second edge surface 12 and a first joinery element surface 13. The second edge surface 12 is adjacent to said first edge surface 11. A first attaching surface 15 is at least part of the first edge surface 11 (see FIGS. 1 and 3) or the second edge surface 12 (see FIG. 2).

As will be understood by a person skilled in the art, any surface, such as any planar surface, may constitute an attaching surface, although for shipping purposes, e.g., for enabling flat packs, the first attaching surface may be (or may be a part of) an edge surface.

The joinery product further comprises a second joinery element 20 having a second joinery element surface 22, a third joinery element surface 23, a third edge surface 21 and a fourth edge surface 24. A second attaching surface 25 is at least part of said second joinery element surface 22 (see FIGS. 2, 3), the third edge surface 21 (FIG. 1) or the fourth edge surface 24 (see FIG. 3). The first attaching surface 15 faces, and is configured to be locked with, the second attaching surface 25.

The cross section of the joinery elements may be squared, e.g., when the joinery element is a stud. Thus, the second joinery element surface 22 and the fourth edge surface 24 may be of similar width (see FIG. 3).

The joinery product further comprises a mechanical locking device comprising at least two dowels 31 protruding from the first attaching surface 15 and a compressible locking element 40 partially protruding from the first attaching surface 15 in the uncompressed state, such as in the locked position.

The first joinery element 10 and/or the second joinery element 20 may be a wood based joinery element. The joinery elements according to the disclosure may have a cuboid shape, such as a cuboid shape with right angles. The joinery elements may have 1 to 4 mitered edges, or rabbet or half lap joints. The cross sections of the joinery elements may be of any shape, such as a rectangular or quadratic shape, optionally with one or two decoratively milled surfaces. The joinery elements may be panels, boards or studs, optionally with 1 to 4 mired edges, such as 1 or 2, or 1 to 4 rabbet or half lap joints, optionally with 1 or 2 decoratively milled surfaces.

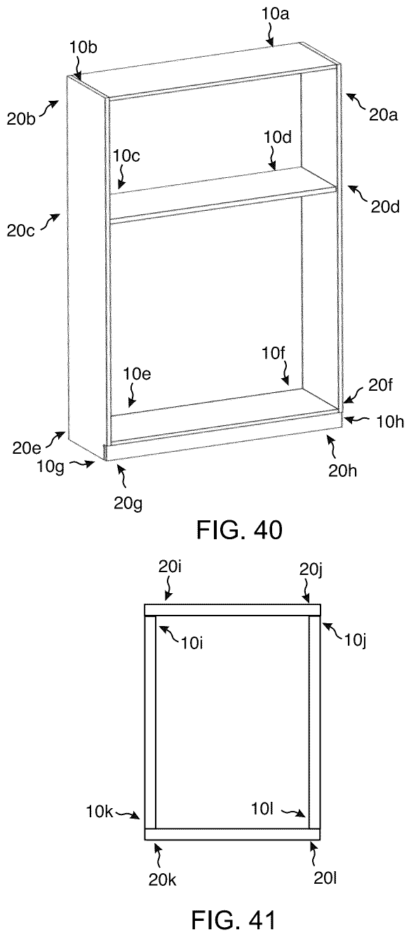

The first joinery element 10 and/or the second joinery element 20 may be a part of a furniture product or a frame. A furniture product may be a bookshelf (see FIG. 40), a cupboard, a wardrobe, a box, a drawer, a kitchen cabinet, a countertop, or a tabletop. A frame may be a door frame or a window frame (see FIG. 41). One or more joinery elements in a product may comprise more than one mechanical locking device and a product may comprise various examples joinery elements assembled with the mechanical locking device. A joinery element may further act as a first joinery element 10 when assembled to one joinery element, while acting as the second joinery element in a locked position with another joinery element. This is illustrated in FIGS. 40 and 41. For example, in FIG. 40 one panel acts as a first joinery element in 10h, while acting as a second joinery element in 20a, 20d and 20f.

The attaching surface may be planar.

The wood based joinery element may be a particle board, an HDF, an MDF or a plywood joinery element. Further details of the mechanical locking device are described below and are applicable to any configuration described in FIGS. 1 to 3.

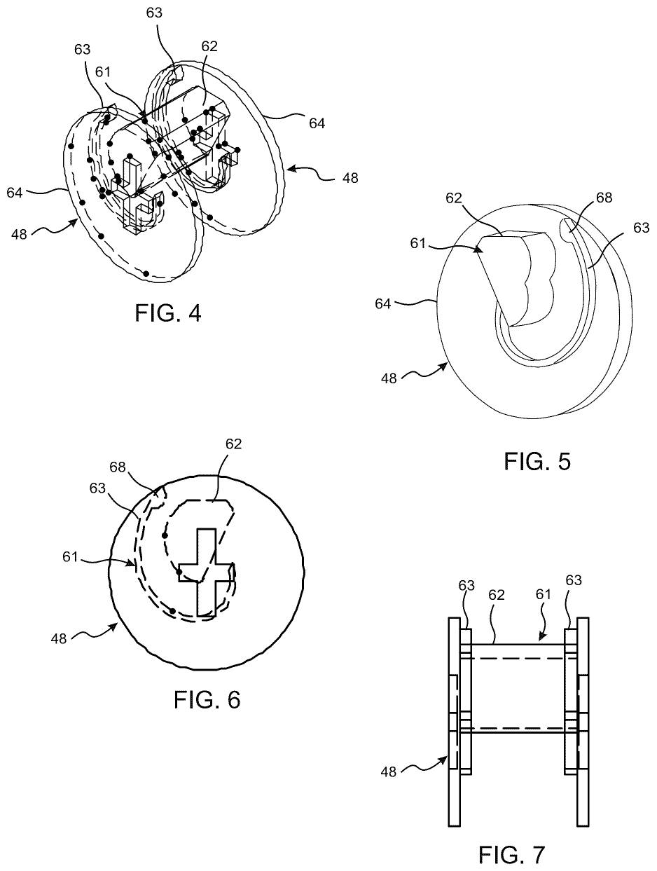

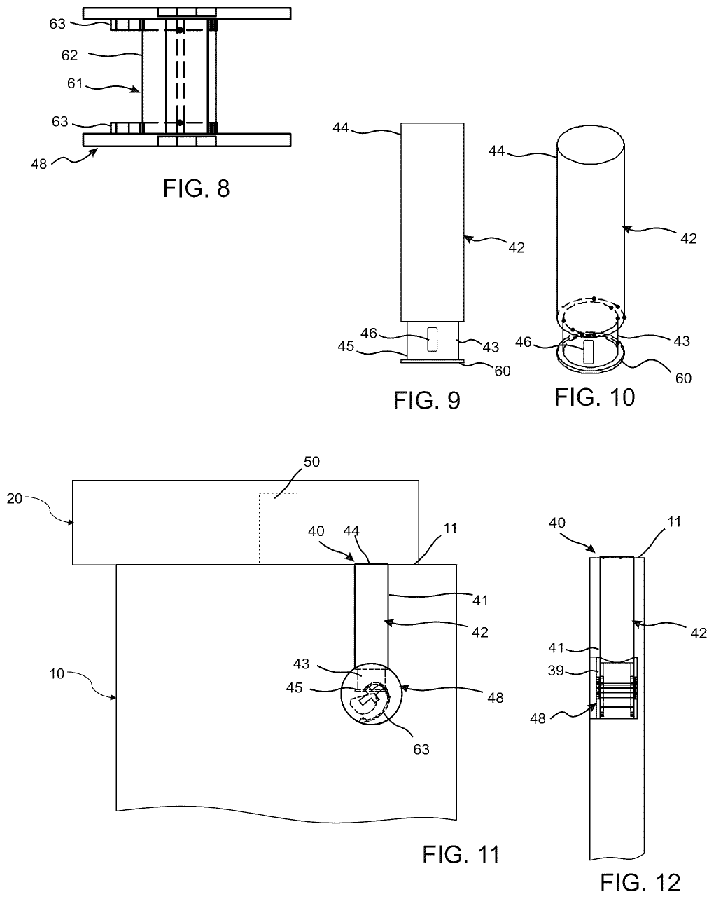

Referring to FIGS. 4-10, a locking device according to one embodiment of the present disclosure will be described. The locking device 40 comprises a locking pin 42. The locking pin 42 can be used for locking two elements to one another. In one embodiment, the locking pin may comprise a compressible portion 43. In other embodiments, the locking pin 42 does not comprise any compressible portion.

The compressible portion 43 of the locking pin 42 may comprise a polymer material, such as a thermoplastic material, optionally with an enforcement, such as glass fibre. The compressible portion 43 may be a static load compressible spring.

The compressible portion 43 and remainder of the locking pin 42 may be injection moulded in one piece.

The locking pin 42 may comprise a radial recess 46 which may optionally extend through the locking pin 42. The recess 46 in the locking pin may be a through hole such that there is a recess opening and a recess exit.

Referring to FIGS. 4-16, one embodiment of a locking device 40 is described.

Referring to FIGS. 9-10, the locking pin 42 comprises an elongated main body with a first end portion 44 and a second end portion 45. A flange 60 is provided in the second end portion 45. The flange 60 protrudes radially from the main body, in a direction substantially perpendicular to the axial extension of the main body of the locking pin 42.

Referring to FIGS. 4-8, the locking device 40 further comprises a plug element 48. The plug element 48 may be configured to cooperate with the locking pin 42. The plug element 48 may achieve a locking and unlocking of the locking pin 42 when mounted in a joinery product.

The plug element 48 comprises engagement means 61 which may be configured to interact with the locking pin 42. The engagement means 61 may be configured to interact with the flange 60 of the locking pin 42.

The engagement means 61 comprises in the embodiment shown in FIGS. 4-8 a support means 62 and guide means 63. The support means 62 may be configured to support the locking pin 42 in a locked position.

The expression “support”/“supported” is meant to be understood as, in this embodiment, the support means 62 abuts, or is in contact with the locking pin 42 in such manner that the locking pin 42 rests on the support means 62. Due to the support from the support means 62, the locking pin 42 is not able to move beyond the support means 62 within the element recess 41 in the direction towards the support means 62.

The expression “unsupported” has the opposite meaning compared to the expression “supported.” Thus, “unsupported” is meant to be understood as, in this embodiment, the locking pin 42 does not abut, or is not in contact with, the support means 62. Due to the lack of contact between the locking pin 42 and the support means 62, the locking pin 42 is not restrained, at least not by the support means 62, from moving within the element recess 41. In other words, the locking pin 42 is free to move within the element recess 41, at least with reference to the support means 62.

The terms “supported”/“unsupported” have the corresponding meaning throughout the other embodiments described in this application.

The guide means 63 may be configured to guide, or bring, or convey, the locking pin 42 from a first position to a second position and vice versa. The guide means 63 may be configured to guide the locking pin 42 from a locked position to an unlocked position and vice versa. The first position of the locking pin 42 may correspond to an unlocked position of the locking device. The second position of the locking pin 42 may correspond to a locked position of the locking device.

The plug element 48 may comprise two disc elements 64. The disc elements 64 may have equal outer diameters. The disc elements 64 may have different outer diameters, one disc element 64 having a larger outer diameter compared to the other disc element 64. The disc elements 64 may be arranged on a common axis, or may be arranged offset relative to each other. The two discs 64 may be interconnected by the support means 62.

The guide means 63 may comprise two arms. The arms 63 may be arranged on a side portion of each disc 64 facing towards the respective other disc 64. The arms 63 may extend from a centre area of the respective discs 64, towards a rim area of the respective discs 64. The arm 63 may be a curved arm. The curvature of the arm 63 may be non-uniform. For example, the arm 63 may be spirally curved. The arm 63 may have a first curvature radius closer to the centre area of the disc 64. The arm 63 may have a second curvature radius closer to the rim area of the disc 64. For example, the curvature radius is larger closer to the rim area of the disc 64 compared to the curvature radius closer to the centre portion of the disc 64.

The arm 63 may be configured to interact with the locking pin 42, preferably with the flange 60 of the locking pin 42, by rotation of the plug element 48. The arm 63 may be provided with a hook member 68 in one end portion of the arm 63. Preferably, the hook member 68 is arranged in the end portion proximal the rim of the disc 64. The hook member 68 may be configured to interact with the flange of the locking pin 42.

In one embodiment, the support means 62 is irregularly shaped. The irregular shape may comprise at least one at least substantially flat surface. The at least one at least substantially flat surface may be configured to support the locking pin 42 in a second position, which may be a locked position.

Referring to FIGS. 11-16, the functioning of the locking device 40 according to FIGS. 4-10 will be described. The locking device 40 is arranged in a first joinery element 10. The locking pin 42 is arranged in a first joinery element recess 41, and the plug element 48 is arranged in a first joinery element opening 39. A second joinery element 20 is to be fastened, or joined to, the first joinery element 10. The second joinery element comprises a locking recess 26. The locking recess 26 is configured to receive at least a portion of the locking pin 42.

In FIGS. 11-12, the second joinery element 20 is arranged in an abutting manner against the first joinery element such that the compressible portion 43 of the locking pin 42 is compressed such that the first end portion 44 of the locking pin 42 is arranged approximately flush with the edge surface 11 of the first joinery element 10, or housed within the first joinery element recess 41.

The arms 63 are engaged with the flange 60, pulling the locking pin 42 downwards, i.e., into the first joinery element 10. The locking device 40 is in the unlocked position.

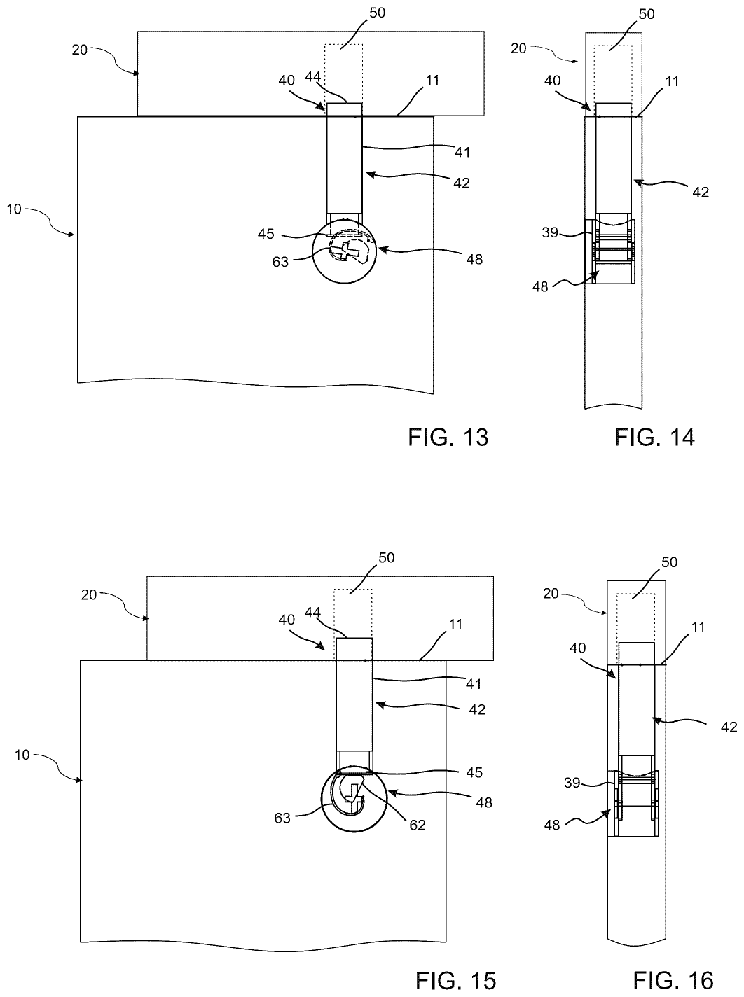

In FIGS. 13-14, the plug element 48 has been rotated counterclockwise approximately 90° compared to the position shown in FIGS. 11-12. The arms 63 slides along the flange 60 of the locking pin 42, and the curved shape of the arms 63 allow the locking pin 42 to move upwards, i.e., out of the first joinery element recess 41. The arms 63 are configured, upon rotation of the plug element 48, to push the locking pin 42 in a direction out of the first joinery element recess 41. In illustrative embodiments, upon rotation of the plug element 48 from the position shown in FIGS. 11-12 to the position shown in FIGS. 13-14, the plug element 48 pushes against the locking pin 42, thus causing displacement of an entirety of the locking pin 42 in a locking direction. This is accomplished by the interaction between the curved arms 63 and the flange 60. The curved arms 63 hook into the flange 60 and upon rotation of the plug element 48, due to the curvature of the arms 63, the locking pin 42 is forced to move within the first joinery element recess 41.

In FIGS. 15-16, the plug element 48 has been rotated counterclockwise approximately 180° compared to the position shown in FIGS. 11-12. The arms 63 has released the flange 60 and the second end portion 45 of the locking pin 42 rests on the support means 62. The locking pin 42 cannot move further into the first joinery element recess 41. Thus, the first end portion 44 of the locking pin 42 protrudes out of the first joinery element recess 41 and cannot be pushed back into the first joinery element recess 41. Thus, the locking device 40 is in the locked state.

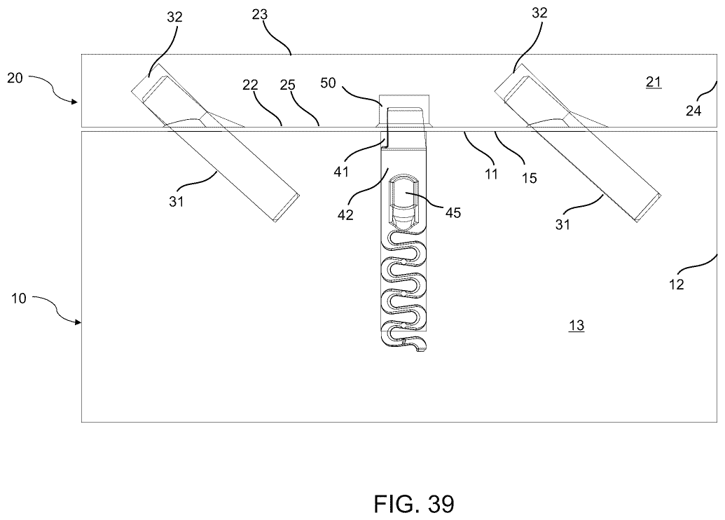

In the locked state of the locking device 40, the locking pin 42 may extend into a locking recess 50 of a second joinery element 20, in order to lock the first 10 and second 20 joinery elements to each other. This is shown schematically, without the plug element, in FIG. 39.

The process of interlocking the first joinery element 10 and the second joinery element 20 may be a combination of the compressible portion 43 of the locking pin 42 being compressed/uncompressed and the rotation of the plug element 48. Alternatively, the locking element does not comprise a compressible portion, and the interlocking is achieved by the rotation of the plug element, moving the locking pin to extend into the locking recess of the second joinery element.

In order to unlock the locking device 40, i.e., to release the locked locking pin 42, the plug element 48 is rotated in the opposite direction, i.e., clockwise direction. Thus, the arms 63 engage with the flange 60. The support means 62 is rotated away from its supporting position, allowing the locking pin 42 to move into first joinery element recess 41 (FIGS. 13-14).

Upon further rotation of the plug element 48, the curvature of the arms 63 pull the locking pin 42 downwards, into the first joinery element recess 41. As the flange 60 engages with portions of the arms 63 having gradually decreasing radii of the curvature, the locking pin 42 is pulled further into the first joinery element recess 41. When the first end portion 44 of the locking pin 42 is approximately flush with the first edge surface 11 of the first joinery element 10, or housed within the first joinery element recess 41, the locking device 40 is in the unlocked state, and the first 10 and second 20 joinery elements may be removed from each other (FIGS. 11-12).

In one embodiment, the locking pin 42 is a compressible locking pin. The locking device 40 is arranged in the first joinery element 10. The locking pin 42 is arranged in the first joinery element recess 41, and the plug element 48 is arranged in the first joinery element opening 39. The second end portion 45 of the locking pin 42 is abutting the support means 62. The second joinery element 20 is arranged in abutting contact with the first joinery element 10, such that the locking pin 42 is compressed against the support means 62. Upon displacement of the second joinery element 20 such that the locking recess 50 is arranged in line with the locking pin 42, the compressible portion 43 of the locking pin 42 is uncompressed such that the first end portion 44 of the locking pin 42 extends into the locking recess 50. The locking device 40 is thus in the locked position.

In order to unlock the locking device 40, the same procedure as described above is followed.

In an alternative embodiment, the arms 63 of the engagement means 61 may extend in an opposite direction compared to the direction shown in the Figures. In this case, the rotational directions will be opposite to the ones described above.

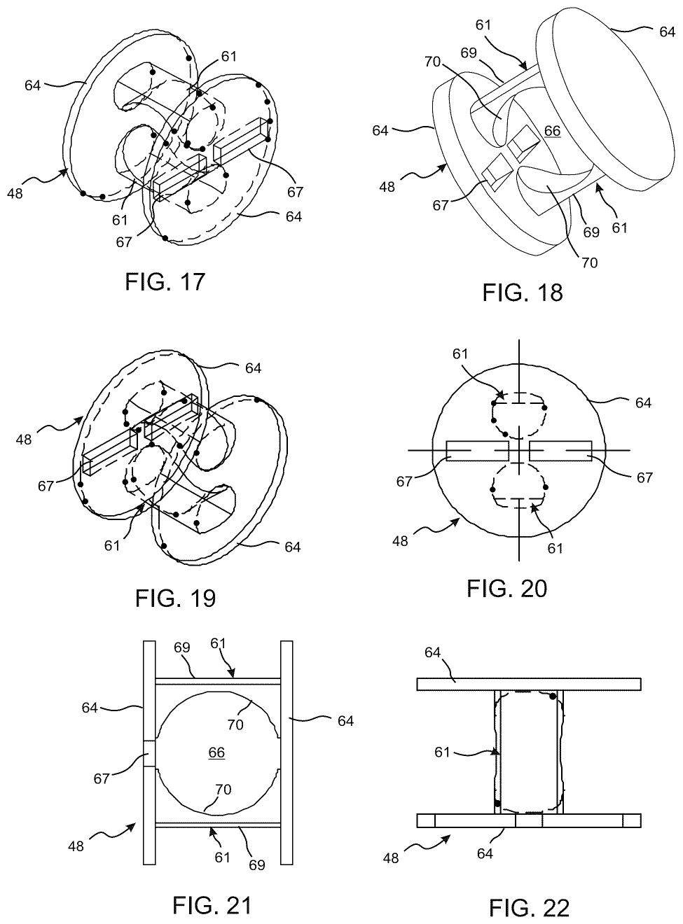

Referring to FIGS. 17-28, a locking device 40 according to one embodiment of the present disclosure will be described. A plug element 48 according to one embodiment is shown in FIGS. 17-22. The plug element 48 comprises two disc elements 64. The disc elements 64 may have equal diameters. The disc elements 64 may have different diameters, one disc element 64 having a larger diameter compared to the other disc element 64. The disc elements 64 may be arranged on a common axis, or may be arranged offset relative to each other.

The disc elements 64 may be connected by means of engagement means 61. The engagement means 61 may comprise a structure having an arc portion 70 on one side and a flat portion 69 on an opposite side. The flat portion functions as a support means. Attachment surfaces, configured to attach the engagement means 61 to the discs 64 may be provided at 90° angles relative the arc portion 70 and flat portion 69.

The attachment surfaces may be adhered to one of the main surfaces of each disc element 64 interconnecting the disc elements 64. The disc elements 64 may be interconnected by means of two such engagement means 61. The engagement means 61 may be arranged such that the flat portions 69 of each engagement means 61 faces away from each other. The engagement means 61 may be arranged such that the arc portions of each engagement means 61 faces towards each other. The arc portions 70 facing each other may form an opening 66 therebetween. The opening 66 may be circular, approximately circular, oval, approximately oval, semi-circular with straight portions, semi-oval with straight portions. The opening 66 may be configured to receive the locking pin 42 in an unlocked position of the locking device 40.

One or both disc elements 64 may be provided with one or more through recesses 67 or openings. The locking pin 42 may be accessible and maneuverable via the at least one through recess 67. The locking pin 42 may be movable into and out of the opening 66 of the plug element 48 by means of e.g., manual interaction with the locking pin 42 through the at least one through recess 67. The interaction may e.g., be performed by means of a tool (e.g., a screwdriver) inserted into the through recess 67.

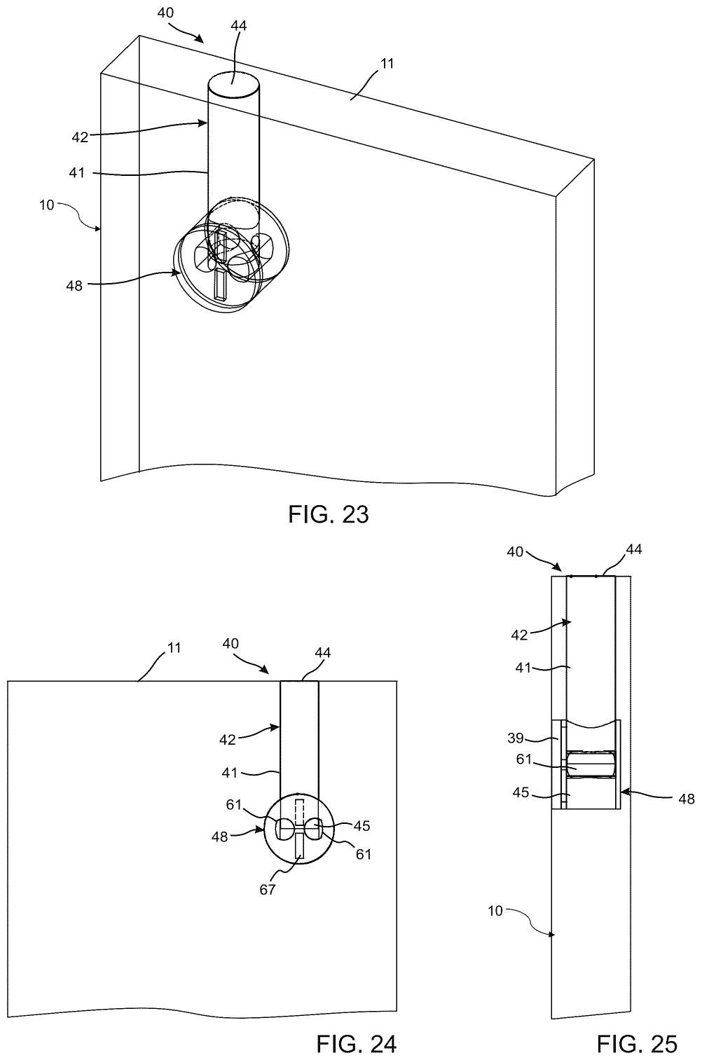

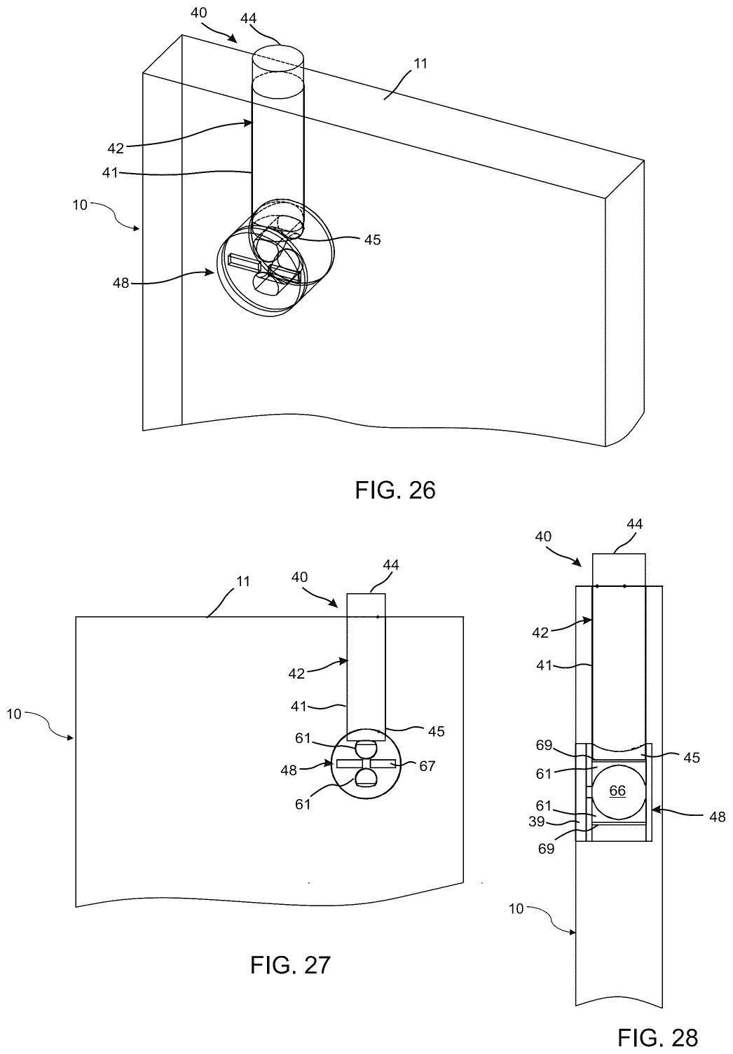

Referring to FIGS. 23-28, the locking device 40 with a plug element 48 according to the embodiment shown in FIGS. 17-22 is shown mounted in a first joinery element 10. The locking pin 42 is arranged in a first joinery element recess 41, and the plug element 48 is arranged in a first joinery element opening 39. In FIGS. 23-25, the locking device 40 is shown in an unlocked state. In FIGS. 26-28, the locking device 40 is shown in a locked state.

In the unlocked state, as shown in FIGS. 23-25, the locking pin 42 of the locking device 40 is arranged in a first joinery element recess 41 of a first joinery element 10. The plug element 48 is arranged such that the opening 66 formed between the engagement means 61 is parallel with the edge surface 11, and thus perpendicular to the longitudinal extension of the locking pin 42. In this configuration, the second end portion 45 of the locking pin 42 is received in the opening 66, such that the first end portion 44 of the locking pin 44 is approximately flush with the edge surface 11, or housed within the first joinery element recess 41. The locking device 40 is thus in an unlocked state.

In order to put the locking device 40 in the locked state, as shown in FIGS. 26-28, the locking pin 42 is pushed in an upwards direction of the drawing, i.e., towards the edge surface 11, by means of an interaction via the through recess 67 in the disc 64. The locking pin 42 may be interacted with by means of a tool inserted in the through recess 67, or manually, e.g., by means of a finger of a person operating/handling/maneuvering the locking device 40. Once the first end portion of the locking pin 44 has reached an upper position, the plug element 48 is rotated approximately 90°, in any direction. Thus, the opening 66 formed between the engagement means 61 is perpendicular to the edge surface 11, and parallel with the longitudinal extension of the locking pin 42. The locking pin 42 cannot enter the opening 66 in this position of the plug element 48. Instead, the flat surface 69 of one of the engagement means 61 is arranged below, with reference to the drawings, the second end portion 45 of the locking pin 42. In other words, the flat surface 69 of one of the engagement means 61 is arranged in an abutting manner relative the second end portion 45 of the locking pin 42. The second end portion 45 of the locking pin 42 may rest against the flat surface 69 of said engagement means 61. The second end portion 45 of the locking pin 42 may be supported by the flat surface 69 of said engagement means 61. In this position of the plug element 48, the locking pin 42 cannot move further into the first joinery element recess 41, i.e., in the direction towards the plug element 48. Thus, the first end portion 44 of the locking pin 42 protrudes out of the first joinery element recess 41 and the locking device 40 is in the locked state.

In the locked state of the locking device 40, the locking pin 42 may extend into a locking recess 50 of a second joinery element 20, in order to lock the first 10 and second 20 joinery elements to each other. This is shown schematically, without the plug element, in FIG. 39.

To unlock the locking device 40, i.e., to release the locked locking pin 42, the plug element 48 is again rotated approximately 90° in any direction. The locking pin 42 falls into the opening 66 between the engagement means 61 by means of gravity, or it is maneuvered via the through recess 67 such that the second end portion 45 of the locking pin 42 extends into the opening 66. When the first end portion 44 of the locking pin 42 is approximately flush with the first edge surface 11 of the first joinery element 10, or housed within the first joinery element recess 41, the locking device 40 is in the unlocked state, and the first 10 and second 20 joinery elements may be released from each other.

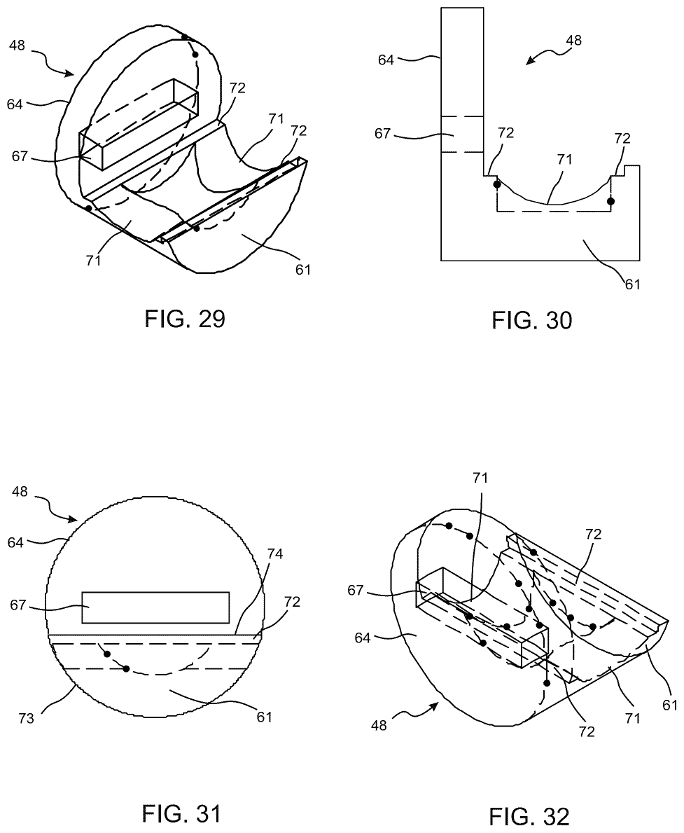

Referring to FIGS. 29-38, a locking device 40 according to one embodiment of the present disclosure will be described. A plug element 48 according to one embodiment is shown in FIGS. 29-32. The plug element 48 comprises one disc element 64. The disc element 64 is provided with a through recess 67 or opening. The locking pin 42 may be accessible and maneuverable via the at least one through recess 67. The locking pin 42 may be movable by means of e.g., manual interaction with the locking pin 42 via the at least one through recess 67.

The plug element 48 further comprises an engagement means 61 extending at right angle from one of the main surfaces of the disc element 64. The engagement means 61 comprises a semi-circular element having an arc 73 corresponding to a portion of the disc element 64 and a chord extending below (with reference to the drawings) the centre of the disc 64, as best seen in FIG. 31. The chord may be offset relative the radius of the disc 64. The chord may be offset relative the radius of the disc 64 in a direction towards the arc 73. The engagement means 61 thus makes up less than half a circle, seen in the view of FIG. 31.

In the chord portion 73, the engagement means 61 comprises a recessed portion or indentation 71. The recessed portion may be a cupped recessed portion. Preferably, the curvature of the cupped recessed portion 71 corresponds to the mantle surface of the locking pin 42 such that the locking pin 42 may be received by the recessed portion 71. Support means in the form of shelves 72 are arranged along the chord portion 73, on either side of the recessed portion 71, one shelf proximal to the disc element 64 and one shelf 72 distal from the disc element 64.

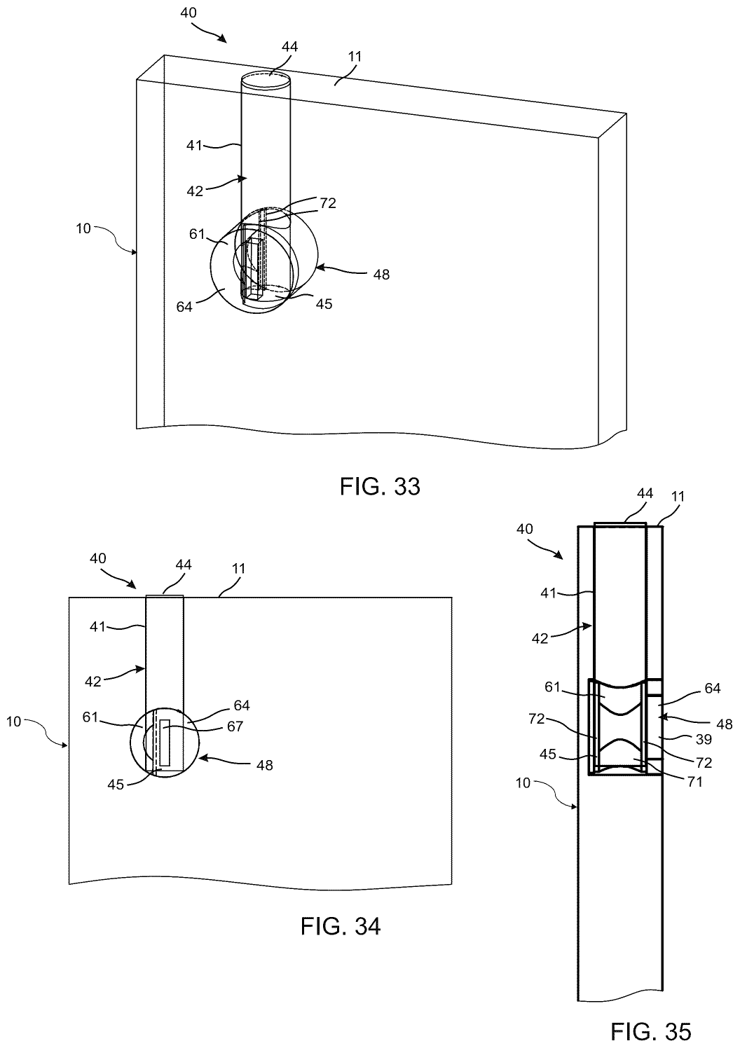

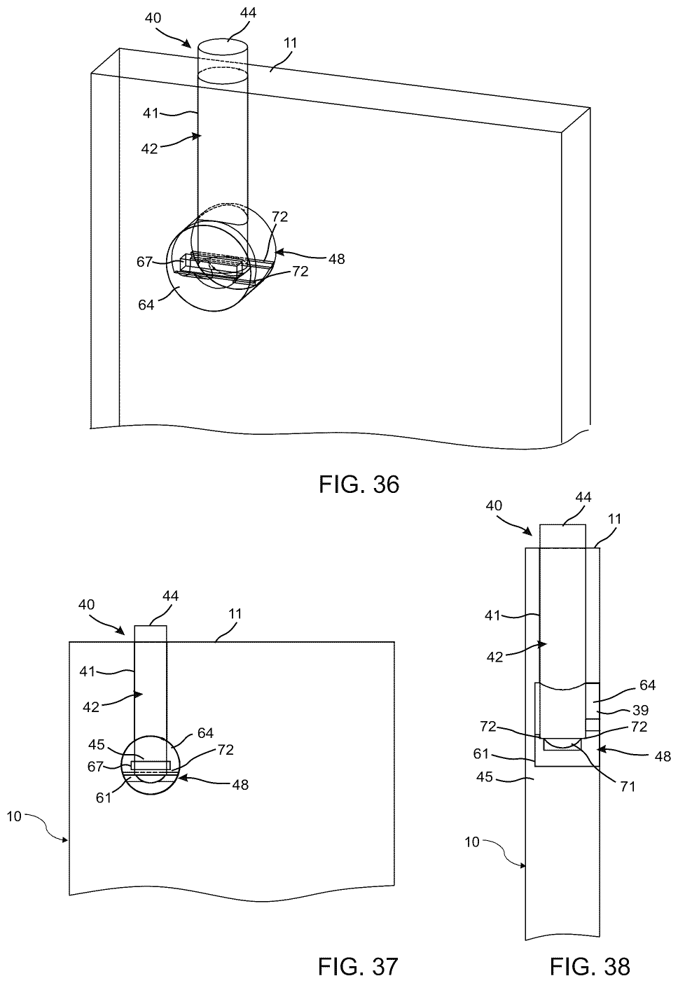

Referring to FIGS. 33-38, the locking device 40 with a plug element 48 according to the embodiment shown in FIGS. 29-32 is shown mounted in a first joinery element 10. The locking pin 42 is arranged in a first joinery element recess 41, and the plug element 48 is arranged in a first joinery element opening 39. In FIGS. 33-35, the locking device 40 is shown in an unlocked state. In FIGS. 36-38, the locking device 40 is shown in a locked state.

In the unlocked state of the locking device 40, the plug element 48 is rotationally arranged such that the extension of the recessed portion 71 of the engagement means 61 is parallel with the longitudinal extension of the locking pin 42. The locking pin 42 is received in the recessed portion 71. The longitudinal extension of the locking pin 42 is substantially entirely received in the first joinery element recess 41 such that the first end portion 44 of the locking pin 44 is approximately flush with the edge surface 11, or housed within the first joinery element recess 41. The locking device 40 is thus in an unlocked state.

In order to put the locking device 40 in the locked state, as shown in FIGS. 36-38, the locking pin 42 is pushed in an upwards direction of the drawing, i.e., towards the edge surface 11, by means of an interaction via the through recess 67 in the disc 64. The locking pin 42 may be interacted with by means of a tool inserted in the through recess 67, or manually, e.g., by means of a finger of a person operating/handling/maneuvering the locking device 40. Once the first end portion 44 of the locking pin 42 has reached an upper position, the plug element 48 is rotated counterclockwise approximately 90°. Alternatively, the plug element 48 is rotated approximately 270° in the clockwise direction.

If the engagement means 61 had been situated to the right-hand side of the locking pin 42 in the unlocked state, the rotation would be a clockwise rotation of approximately 90°, or a counterclockwise rotation of approximately 270°.

In this position of the plug element 48, the shelves 72 of the engagement means 61 is arranged below, with reference to the drawings, the second end portion 45 of the locking pin 42. In other words, the shelves 72 of the engagement means 61 is arranged in an abutting manner relative the second end portion 45 of the locking pin 42. The second end portion 45 of the locking pin 42 may rest against the shelves 72 of said engagement means 61 and cannot move further into the first joinery element recess 41. The second end portion 45 of the locking pin 42 may be supported by the shelves 72 of said engagement means 61.

Thus, the first end portion 44 of the locking pin 42 protrudes out of the first joinery element recess 41 and the locking device 40 is in the locked state.

In the locked state of the locking device 40, the locking pin 42 may extend into a locking recess 50 in a second joinery element 20, in order to lock the first 10 and second 20 joinery elements to each other. This is shown schematically, without the plug element, in FIG. 39.

To unlock the locked locking device 40, i.e., to release the locked locking pin 42, the plug element 48 is rotated back to the position in which the recessed portion 71 of the engagement means 61 is parallel with the longitudinal extension of the locking pin 42. The locking pin 42 is then maneuvered, via the recess 67 in the disc 64, further into the first joinery element recess 41 such that it is received by the recessed portion 71, and such that the first end portion 44 of the locking pin 42 is substantially flush with the first edge surface 11 or housed within the first joinery element recess 41. The locking device 40 is unlocked, and the first 10 and second 20 joinery elements may be removed from each other.

Embodiments of the rotatable plug element 48 may comprise a polymer material, such as a thermoplastic material.

The rotatable plug element 48 may be injection moulded in one piece.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teaching of the present disclosure is/are used.

The indefinite articles “a” and “an,” as used herein in the specification and in the claims, unless clearly indicated to the contrary, should be understood to mean “at least one”.

Other aspects of the inventive concept are provided below.

Item 1. A locking device for a joinery product, the locking device comprising:
a locking pin, a rotatable plug element, the plug element having at least one engagement means configured to interact with the locking pin such that:
in a first rotation state of the plug element, the locking pin is positionable in a first position, and
in a second rotation state of the plug element, the locking pin is positionable in a second position, different from the first position.

Item 2. The locking device according to item 1, wherein the locking pin is unsupported by the engagement means in the first position, and supported by the engagement means in the second position.

Item 3. The locking device according to any one of items 1-2, wherein the engagement means comprises at least one support means configured to support the locking pin in the second position.

Item 4. The locking device according to item 3, wherein the at least one support means is located below the locking pin in the second rotation state of the plug element, optionally such that the at least one support means abut an end portion of the locking pin such that the locking pin is supported by the at least one support means in the second position.

Item 5. The locking device according to any one of items 3-4, wherein in the first rotation state of the plug element, the at least one support means is located in a non-supportive position in relation to the locking pin, and wherein, in the second rotation state of the plug element, the at least one support means is rotated approximately +/−90° compared to the orientation of the at least one support means in the first rotation state of the plug element.

Item 6. The locking device according to any one of items 1-5, wherein the locking pin comprises a flange, and wherein the engagement means further comprises guide means configured to interact with said flange.

Item 7. The locking device according to item 6, wherein the guide means comprises two curved arms configured to interact with the flange of the locking pin, and configured, upon rotation of the plug element from the first rotation state to the second rotation state, to push the locking pin from the first position to the second position.

Item 8. The locking device according to any one of items 6-7, wherein, upon rotation of the plug element from the second rotation state to the first rotation state, the guide means are configured to pull the locking pin from the second position to the first position.

Item 9. The locking device according to any one of items 3-5, wherein the plug element comprises an opening arranged in a 90° angle in relation to the at least one support means, and wherein the opening is configured to receive the locking pin in the first position.

Item 10. The locking device according to item 9, wherein the plug element comprises two support means, provided on respective sides of the opening.

Item 11. The locking device according to item 10, wherein, in the second position, the locking pin is configured to be supported by one of the two support means.

Item 12. The locking device according to any one of items 9-11, wherein the plug element further comprises at least one through recess configured to provide access to the locking pin, optionally by means of a tool.

Item 13. The locking device according to item 12, wherein the locking pin is maneuverable between the first and second positions via the at least one recess, optionally by means of a tool.

Item 14. The locking device according to any one of items 1-5, wherein the plug element comprises an indentation configured to receive the locking pin in the first position.

Item 15. The locking device according to item 14, further comprising two support means provided on respective sides of the indentation, wherein the locking pin is configured to be supported by both support means in the second position.

Item 16. The locking device according to any one of items 1-15, wherein the locking pin and/or the rotatable plug element comprises a polymer material, such as a thermoplastic material.

Item 17. The locking device according to any one of items 1-16, wherein the rotatable plug element is injection moulded in one piece.

1. A locking device for a joinery product, the locking device comprising:
a compressible locking pin, comprising a flange, and
a rotatable plug element having at least one engagement means comprising two curved arms,
wherein in a first rotation state of the plug element, the locking pin is positioned in a first position, and in a second rotation state of the plug element, the locking pin is positioned in a second position, different from the first position, wherein the first position is an unlocked position of the locking device, and the second position is a locked position of the locking device,
wherein upon rotation of the plug element from the second rotation state to the first rotation state, the curved arms are configured, by interaction with said flange, to pull the locking pin from the locked position to the unlocked position.

2. The locking device according to claim 1, wherein the locking pin is unsupported by the engagement means in the first position and supported by the engagement means in the second position.

3. The locking device according to claim 1, wherein the engagement means comprises at least one support means configured to support the locking pin in the second position.

4. The locking device according to claim 3, wherein the at least one support means is configured such that the at least one support means abut an end portion of the locking pin such that the locking pin is supported by the at least one support means in the second position.

5. The locking device according to claim 3, wherein in the first rotation state of the plug element, the at least one support means is located in a non-supportive position in relation to the locking pin, and wherein, in the second rotation state of the plug element, the at least one support means is rotated approximately +/−90° compared to the orientation of the at least one support means in the first rotation state of the plug element.

6. The locking device according to claim 1, wherein, upon rotation of the plug element from the second rotation state to the first rotation state, the guide means are configured to pull the locking pin from the second position to the first position.

7. The locking device according to claim 1, wherein, the compressible locking pin is de-compressible to an initial state after having been compressed.

8. The locking device according to claim 1, wherein the locking pin and/or the rotatable plug element comprises a polymer material, such as a thermoplastic material.

9. The locking device according to claim 1, wherein the rotatable plug element is injection moulded in one piece.

10. The locking device according to claim 1, wherein, upon rotation of the plug element from the first rotation state to the second rotation state, the plug element pushes against the locking pin, thus causing displacement of an entirety of the locking pin in a locking direction.

11. A locking device for a joinery product, the locking device comprising:
a compressible locking pin, and
a rotatable plug element having at least one engagement means comprises at least one support means and an opening arranged in a 90° angle in relation to the at least one support means,
wherein in a first rotation state of the plug element, the locking pin is positioned in a first position, and in a second rotation state of the plug element, the locking pin is positioned in a second position, different from the first position,
wherein the opening is configured to receive a portion of the locking pin in the first rotation state of the plug element.

12. A locking device for a joinery product, the locking device comprising:
a compressible locking pin, and
a rotatable plug element comprising an indentation,
wherein in a first rotation state of the plug element, the locking pin is positioned in a first position, and in a second rotation state of the plug element, the locking pin is positioned in a second position, different from the first position,
wherein the indentation is configured to receive a portion of the locking pin in the first rotation state of the plug element.
